(19) United States
(12) Patent Application Publication
(10) Pub. No.: US 2013/0250423 A1
(43) Pub. Date: Sep. 26, 2013

(54) Lap Shade and Method of Shielding Glare

(71) Applicant: Anthony Trantham, Grayson, GA (US)

(72) Inventor: Anthony Trantham, Grayson, GA (US)

(21) Appl. No.: 13/424,559

(22) Filed: Mar. 20, 2012

(51) Int. Cl. G02B 27/00

(52) U.S. Cl. 359/601

(57) ABSTRACT

A lap shade to seal the cavity formed between the pair of beads of a tire including a cover member configured to be inserted approximate the beads of the tire, the cover member further comprising a pair of coupling members configured to each receive one of the beads of the tire and, thus such apparatus, functions to eliminates the need (time and effort) for cleaning and significantly reduces tire and tire bead deterioration caused by damaging agents, reduce the time spent cleaning road debris from within the tire cavity and on the tire bead, and protect the bead of the tire and sidewall from damage.

### TECHNICAL FIELD

The disclosure generally relates to a collapsible shade, more specifically, it is related to a collapsible lap shade to shield glare or unwanted light reflecting from a display device.

### BACKGROUND

Portable electronic viewing devices such as the IPAD™ and gaming devices such as GAMEBOY™ or an ITOUCH™ are often used during transportation or in public places for entertainment purposes or viewing information that becomes displayed on a display panel. When the display is used outdoors or in bright sunlight, the ambient light causes glare on the display. To avoid such glare from direct sunlight the user may adjust the brightness/contrast on the display or reposition the display to counter the effect of the glare or increased light. However, such adjustments oftentimes do not prevent glare in direct sunlight and therefore make viewing the display difficult. Moreover, increasing brightness of the display is an added burden on the battery of the device, thus shortening the viewing time of the display device or electronic viewing device.

Moreover, sometimes the information displayed on the portable electronic viewing device may be confidential to the user or the user's business or organization, and should not be viewed or seen by other persons in the vicinity of the display device. This need for privacy and security is often required especially on buses, airplanes, trains, subways, restaurants and the like where it is relatively easy for person(s) nearby to view the information displayed for the user.

Therefore, it is readily apparent that there is a recognizable unmet need for a lap shade and method of shielding glare that functions to prevent glare on a viewing device and ambient light around the viewers eyes when used outdoors or near a window and, thereby, enhances the users viewing experience and privacy.

### SUMMARY

Briefly described, in an example embodiment, the present apparatus and method overcomes the above-mentioned disadvantages and meets the recognized need for a lap shade and method of shielding glare comprising, in general, a collapsible structure or shell having one or more encompassing sidewalls configured to form a conduit on which is mounted a bottom wall, the conduit further includes an upper first aperture positioned opposite the back wall and configured to conform to a users face and at least one lower second aperture positioned in the one or more encompassing sidewalls and configured to enable insertion of the viewable device within the conduit and alternatively configured for hand insertion therein, to operate the viewable device positioned within the collapsible structure. In use, a display device or electronic viewing device may be inserted through the at least one lower second aperture with the display facing the upper first aperture to create a viewing conduit or direct shaded path between a viewers eye and a display, which blocks bright sunlight or the ambient light that causes glare on the display. The display device or electronic viewing device may include an access opening to provide hand access to operate the display device or electronic viewing device.

According to its major aspects and broadly stated, the present apparatus meets the recognized need for a lap shade to block light that causes glare on a display comprising a structure having one or more sidewalls configured to form a conduit, said structure further includes a first aperture positioned on a first end of said structure configured to conform to the users face, and at least one second aperture positioned on a second and opposite end of said structure configured to encompass the display.

In a further exemplary embodiment, a lap shade to block light that causes glare on a display comprising a structure having one or more sidewalls configured to form a conduit, said structure further includes a first aperture positioned on a first end of said structure configured to conform to the users face, a bottom positioned on a second and opposite end of said structure configured to form a base to said structure, and at least one second aperture positioned on a second and opposite end of said structure configured to enable insertion of the display therein said structure.

In a further exemplary embodiment of a method of shielding glare comprising the steps of providing a structure having one or more sidewalls configured to form a conduit, said structure further includes a first aperture positioned on a first end of said structure configured to conform to the users face, a bottom positioned on a second and opposite end of said structure configured to form a base to said structure, and at least one second aperture positioned on a second and opposite end of said structure configured to enable insertion of the display therein said structure, positioning said structure on a viewer's lap, inserting the device through at least one second aperture, positioning the viewer's face against said first aperture, and viewing the device through said structure without glare.

Accordingly, a feature of the lap shade and method of shielding glare is its ability to provide a device for reducing glare originating from light sources external to the display.

Another feature of the lap shade and method of shielding glare is its ability to provide a portable collapsible ambient light shield apparatus which, when the display is used outdoors, near a window or in bright ambient light (e.g., sunlight) & placed about a portable electronic viewing device, where the user can view the contents of the display without necessarily moving the display to avoid the interference by ambient light and without necessarily adjusting the brightness/contrast dials on the display.

Yet another feature of the lap shade and method of shielding glare is its ability to move from a collapsed condition for storage and transportation and unfoldable to a deployed condition for use as a glare shield.

Yet another feature of the lap shade and method of shielding glare is its ability to accommodate a variety of portable electronic devices, such as size, shape, and position of hand operation elements.

Yet another feature of the lap shade and method of shielding glare is its ability to provide a stylish lap shade to personalize the appearance of the apparatus for display, marketing and sales purposes.

Yet another feature of the lap shade and method of shielding glare is its ability to provide a low cost, storable and portable apparatus.

Yet another feature of the lap shade and method of shielding glare is its ability to provide an antiglare apparatus formed of a relatively durable material, such as ethylene vinyl acetate (EVA), polyvinyl chloride (PVC), polypropylene (cross linked), or polyurethane.

Yet another feature of the lap shade and method of shielding glare is its ability to provide an antiglare apparatus formed of a disposable material, such as recycled paper.

Yet another feature of the lap shade and method of shielding glare is its ability to be folded or flattened compactly into a small packet that can be easily carried in a storage compartment, pocket or bag or stowed in a pouch of a seat back or under a seat or compacted for shipping.

Yet another feature of the lap shade and method of shielding glare is its ability to provide a direct shaded path from a viewer's eyes to the viewable device.

Yet another feature of the lap shade and method of shielding glare is its ability to provide a direct shaded path from a viewer's eyes to the viewable device, and not being restrictive to the viewer's movement nor partially encompassing the viewer under a hot environment.

Yet another feature of the lap shade and method of shielding glare is its ability to ensure that persons other than the user cannot view the display, thereby preserving the confidentiality of sensitive information.

Yet another feature of the lap shade and method of shielding glare is its ability to increase visual clarity in brightly lit conditions of a viewing device.

Yet another feature of the lap shade and method of shielding glare is its ability to glare and the effects of ambient light when viewing a device.

These and other features of the lap shade and method of shielding glare will become more apparent to one skilled in the art from the following Brief Description of the Drawings, Detailed Drawings, Detailed Description and Claims when read in light of the accompanying drawings.

### BRIEF DESCRIPTION OF THE DRAWINGS

The present lap shade and method of shielding glare or the like will be better understood by reading the Detailed Description of the embodiments with reference to the accompanying drawings, in which like reference to numerals denote similar structures and refer to like elements throughout, and in which:

FIG. 1 is a perspective view of the lap shade;

FIG. 2 is a top view of an alternate example embodiment of the lap shade shown in FIG. 1;

FIG. 3 is a bottom and backside view of an example embodiment of the lap shade shown in FIG. 1;

FIG. 4 is a side view of an example embodiment of the lap shade shown in FIG. 1;

FIGS. 5.1 and 5.2 is a side view of an example and alternate embodiment of the lap shade shown in FIGS. 1 and 2;

FIG. 6.0 is a perspective view of an example embodiment of the lap shade shown in FIG. 1, shown being folded and collapsed for storage;

FIGS. 7.1 and 7.2 is a side view of an example embodiment of the lap shade shown in FIG. 1, shown with height extensions and in use; and

FIG. 8 is a flow diagram of a method of shielding glare or ambient light from a viewable device.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

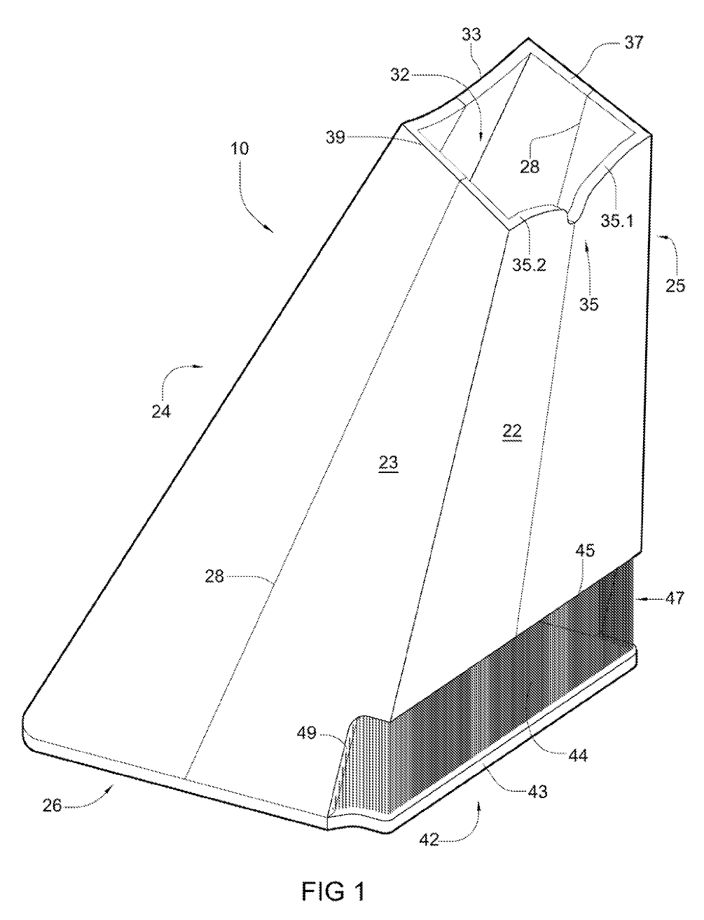

In describing the exemplary embodiments of the present disclosure, as illustrated in FIGS. 1-8 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIG. 1 by way of example, and not limitation, there is illustrated an example embodiment foldable collapsible structure, conduit or shell, such as lap shade 10. Preferably, lap shade 10 includes a formed, cut or shaped set of polygons configured as a flexible planar shell, shroud, conduit or structure having one or more sections such as side 22, 23, 24, and 25, and bottom arranged preferably as, prism, trapezoid or box-like sides forming preferably a topped square based leaning pyramid. It is contemplated herein that configurations other than box, trapezoid or pyramid for lap shade 10 may be utilized herein such as tube, cylinder, cube, conduit or others known to one of ordinary skill in the art. Lap shade is preferably formed, molded or configured from a suitable material, such as expanded polypropylene, polyethylene, polystyrene, polyurethane, neoprene, nylon or alternative resin: plastic, paper, cardboard, canvas, rubber, fiber, foam filled material, fiber reinforced, synthetic rubber, natural rubber, fabric, wood, metal, aluminum, alloy, stainless steel, shape memory metal as a frame with a covering or material, or any flexible sheet or planar material or the like and any manufacturing method, capable of providing structure to lap shade 10. Preferably, the material includes other suitable characteristics, such as light blocking, flexibility, strength, durability, water-resistance, breathability, clean-ability, light weight, pliability, wearability, chemical inertness, oxidation resistance, safety, smoothness, ease of workability, longevity, or other beneficial characteristic understood by one skilled in the art. Sides 22, 23, 24, and 25, and bottom 26 may include a rich-textured or luxurious fabric sheet or surface layer such as cotton, linen, velvet, flock, faux leather (Vienna™), faux suede, silk, burlap, indicia, trademark or the like, or a stain resistant material, such as a soft rubber or polymer, an adhesive, or the like covering an exterior surface of lap shade 10 or marked with an indicia or trademark to provide lap shade 10. Preferably, sides 22, 23, 24, and 25, bottom 26 may be configured to be flat planar adjacent connected surfaces configured to be collapsible, flexible and foldable along fold line 28 to move lap shade 10 from a collapsed condition for storage and transportation to an unfolded position in a deployed condition for use as a glare shield. Further, lap shade 10 may be folded or flattened compactly into a small packet that can be easily carried in a storage compartment, pocket or bag or stowed in a pouch of a seat back or under a seat.

Preferably, lap shade 10 includes one or more cutouts, or holes, such as first aperture 32 and second aperture 42 configured to enable viewing access and display or device insertion and/or hand access into lap shade 10. Preferably, first aperture 32 includes one or more edges, such as edge 33, 35, 37, and 39 configured as ‘goggle like’, straight, concave or rounded, sectioned, to touch, nearly touch, fit or accommodate a viewer's face and create a seal to block ambient light from entering therein, but other shapes for first aperture 32 are contemplated herein. Moreover it is contemplated herein that edges 33, 35, 37, and 39 may include a cushion or soft exterior, such as rubber or felt to create a seal around the viewer's face to block ambient light from entering lap shade 10. Edge 33 of side 24 is preferably straight, angled, rounded, curved or sectioned to create a seal around the viewer's forehead to block ambient light from entering lap shade 10. Edge 37 of side 25 and/or 39 of side 23 may be straight, angled, rounded, curved or sectioned to create a seal around the viewer's temple or side of head to block ambient light from entering lap shade 10. Edge 35 of side 22 is preferably straight, angled, rounded, curved or sectioned to create a seal around the viewer's cheek and bridge of nose to block ambient light from entering lap shade 10. Edge 35 may preferably include a mirror image of edge 35, such as section 35.1 and 35.2 which meet at the bridge of viewer's nose. It is contemplated herein that edges 33, 35, 37, and 39 may be positioned in any of sides 22, 23, 24, or 25. It is contemplated herein that first aperture 32 and one or more edge 33, 35, 37, and 39 may be made available in a variety of sizes, sections and shapes to accommodate various head sizes of viewers.

Preferably, second aperture 42 includes one or more edges, such as edge 43, 45, 47, and 49 configured as straight, concave or rounded, sectioned to enable device insertion and/or hand access to operate the device within lap shade 10. A device or viewing device herein includes portable electronic viewing devices or displays such as the IPAD™, KINDLE™, smart phones, laptop, monitor, personal computer, and gaming devices such as GAMEBOY™, NINTENDO™, or ITOUCH™ or a book or magazine or other viewable object used during transportation or in public places for entertainment purposes or viewing information that becomes displayed on a display panel, referred to herein as device. Preferably, second aperture 42 is configured as a slot or one or more apertures to create a seal and block ambient light around the device but other shapes for second aperture 42 are contemplated herein. Moreover it is contemplated herein that edges 43, 45, 47, and 49 may include a cushion, soft exterior or fringe 44, such as, felt to create a seal around second aperture 42 to block ambient light from entering lap shade 10. Edge 43 of bottom is preferably straight, angled, rounded, curved or sectioned to create a seal, around the viewer's device insertion port (second aperture 42) and/or hands positioned within lap shade 10 to operate such device, to block ambient light from entering lap shade 10. Edge 47 of side 25 and/or 49 of side 23 may be straight, angled, rounded, curved or sectioned to create a seal or provided with a cushion for hand access, or provided with fringe 44, such as felt to create a seal around the viewer's device insertion port (second aperture 42) and/or hands positioned within lap shade 10 to operate such device. Edge 45 of side 22 may be straight, angled, rounded, curved or sectioned to create a seal or provided with a cushion for hand access, or provided with fringe 44, such as, a cuff to create a seal around the viewer's device insertion port (second aperture 42) and/or hands positioned within lap shade 10 to operate such device. It is contemplated herein that second aperture 42 may be positioned in any of sides 22, 23, 24, and 25, or bottom 26.

It is contemplated herein that the viewing device is inserted through insertion port (second aperture 42) of lap shade 10 and, in use; the viewer looks down through lap shade 10 to view a clear glare free device.

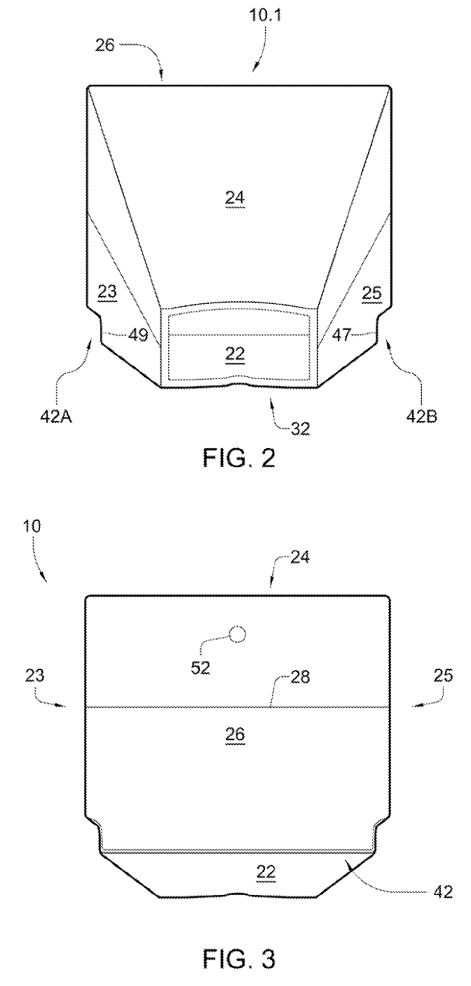

Referring now to FIG. 2 there is illustrated a top view of an example embodiment of lap shade 10.1 and shown with a square base for bottom 26, but other shapes for bottom 26 are contemplated herein. In an alternate embodiment, second aperture 42 may be configured as one or more apertures, such as aperture 42A and 42B having one or more edges 47 and 49 configured to enable hand access within lap shade 10 to operate such device. Moreover, edges 47 and 49 may include a cushion, soft exterior, fringe or cuff 46 to create a seal around second aperture 42A, 42B to block ambient light from entering lap shade 10. It is contemplated herein that second aperture 42 may be positioned in any of sides 22, 23, 24, and 25, or bottom 26. Moreover, bottom 26 may be open to form another aperture or closed as shown bottom 26.

Referring now to FIG. 3 there is illustrated a backside and bottom view of an example embodiment of lap shade 10. Preferably lap shade 10 includes one or more cutouts or holes, such as third aperture 52 to enable access for a power cord to power, for example, a light L source positioned within lap shade 10 or a charging cord to charge a device positioned within lap shade 10. It is contemplated herein that third aperture 52 may be positioned in any of sides 22, 23, 24, and 25, or bottom 26.

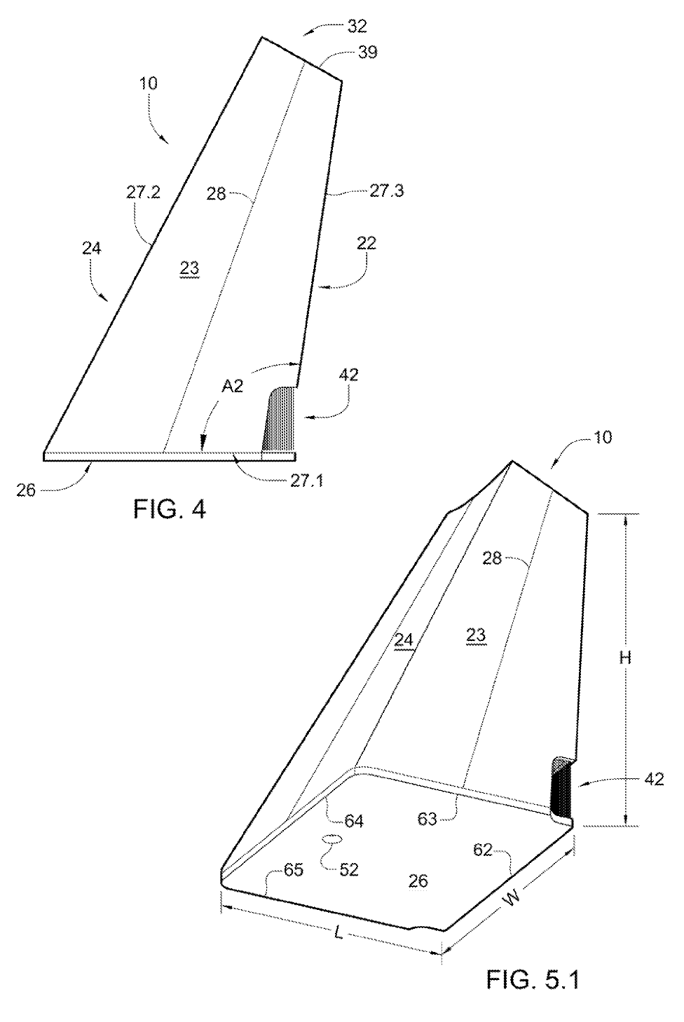

Referring now to FIG. 4 there is illustrated a side view of an example embodiment of lap shade 10. Preferably lap shade 10 includes a seam or transition edges, such as transition edge 27.1, 27.2, and 27.3 between side 23 and bottom 26, side 24, and side 23, and side 22 and bottom 26 respectively. Transition edge 27 may preferably be configured by molding, stitching, adhesive, heat fusion or the like known to one of ordinary skill in the art. Sides 22, 23, 24, and 25, or bottom 26 may be affixed to one another in a similar manner as transition edge 27. The first angle Al between transition edge 27.1 and transition edge 27.2 is preferably an acute angle, less than ninety degrees. The second angle A2 between transition edge 27.1 and transition edge 27.3 is preferably an obtuse angle, greater than ninety degrees. It is contemplated herein that first angle A1 and second angle A2 may be positioned at any angle to accommodate the angle between of the viewer's lap or device position and viewer's eyes or line of sight or the viewer's height.

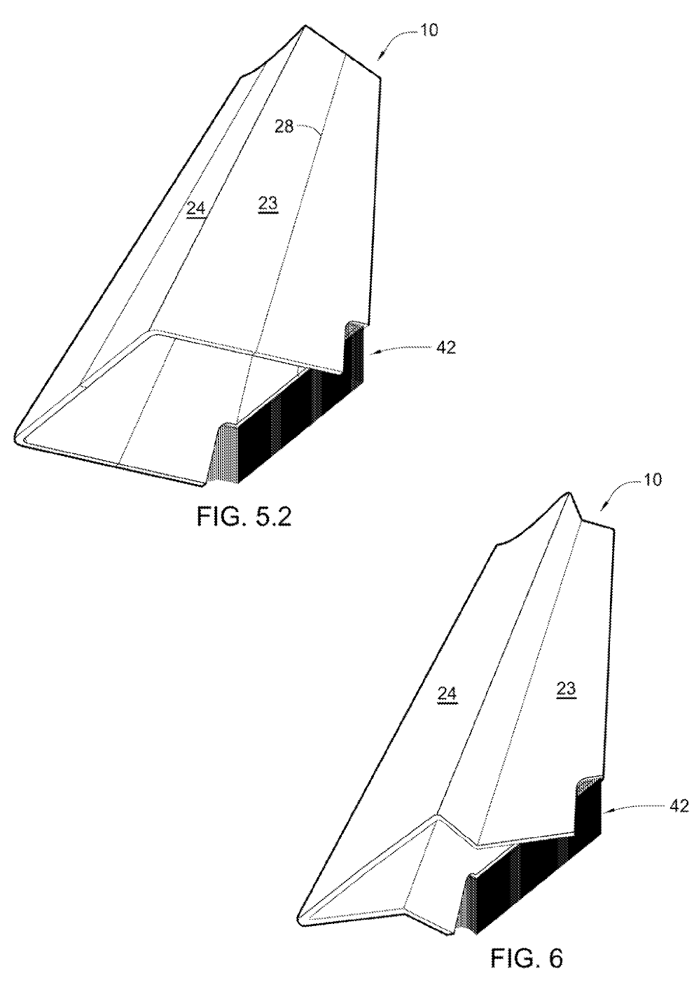

Referring now to FIG. 5.1, in a preferred embodiment, lap shade 10 has approximate preferred dimensions length×width×height, where length L is approximately as great as the distance across a seated person's (child, teen or an adult) thighs or lap, and the width W of sides 23 and 25 is approximately as great as the length of a seated person's (child, teen or an adult) thighs or lap, and the height H of sides 22, 23, 24 and 25 and bottom 26 is approximately as great as the distance between a persons (child, teen or an adult) lap and approximately the person's collar bone. It is recognized herein that lap shade 10 may include dimensions other than those set forth above for example the length×width may be configured to accommodate the dimensions of a particular device. Bottom 26 preferably includes one or more edges, such as edge 62, 63, 64 and 65.

Referring now to FIG. 5.2, in a alternate embodiment, lap shade 10.1 second aperture 42.1 (an opening replaces bottom 26) includes one or more edges, such as edge 62, 63, 64 and 65 and may further include edge 45, 47, and 49 configured to enable coverage of device and insertion or hand access to operate the device covered by lap shade 10.1. Moreover, second aperture 42.1 is configured as an aperture to create a seal and block ambient light around such device but other shapes for second aperture 42 are contemplated herein. Moreover it is contemplated herein that edges 62, 63, 64 and 65 and 45, 47, and 49 may include a cushion, soft exterior or fringe 44, such as, felt to create a seal around second aperture 42.1 to block ambient light from entering lap shade 10.1. Edge 43 of bottom 26 is preferably straight or slightly curved to create a seal, around the viewer's hands positioned within lap shade 10.1 to operate such device, to block ambient light from entering lap shade 10.1. Edge 62, 63, 64 and 65 may be configured as straight, concave or rounded, sectioned to enable device insertion and/or hand access to operate the device within lap shade 10.1 to create a seal or provided with a cushion for hand access, or provided with fringe 44, such as felt to create a seal around the viewer's hands positioned within lap shade 10.1 to operate such device. Edge 45, 47, and 49 may be configured as straight, concave or rounded, sectioned to create a seal or provided with a cushion for hand access, or provided with fringe 44, such as, a cuff to create a seal around the viewer's device insertion port (second aperture 42.1) and/or hands positioned within lap shade 10.1 to operate such device.

It is recognized herein that bottom 26 may not be required for lap shade 10.1 and that in use lap shade 10.1 may be positioned over the device rather that having to insert the device into lap shade 10.

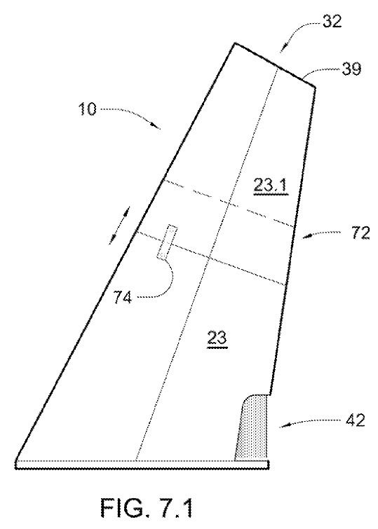

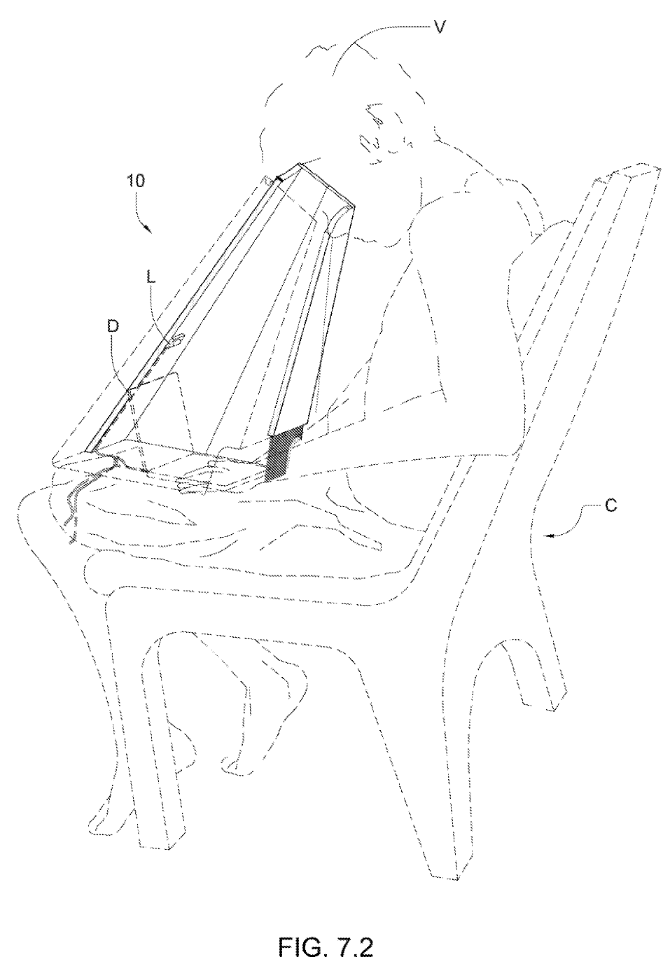

Referring now to FIG. 6 there is illustrated a perspective view of an example embodiment of lap shade 10, shown partially folded and collapsed for storage. Preferably, in FIG. 6, side 23 of lap shade 10 may be folded along fold line 28 and similarly side 25 of lap shade 10 may be folded along fold line 28 and similarly other side may be folded along fold line 28. For FIG. 1 edge 54 between side 24 and bottom 26 may preferably separate to enable folding of lap shade 10. Referring to FIG. 6 again, alternatively, fold line may be a separation line 28 where lap shade 10 may be separated along separation line 28 to enable lap shade 10 to lay flat in a non-use storage position. It is contemplated herein that separation line 28 may be affixed by an attachment apparatus such as snap, button, snap-fit, friction fit, tongue and groove, hook and loop or the like, such as attachment device 54 (shown in FIG. 7). Still further lap shade 10 may be of a bellows construction to enable lap shade 10 to be expanded along fold line 28 (a horizontal rather that a vertical) to an open position for use and collapsible along fold line 28 to a non-use storage position like an accordion. It is contemplated herein that fold line 28 may be positioned vertically as shown or alternatively positioned horizontally. Moreover, if fold line 28 is positioned horizontally then lap shade 10 may be utilized to enable height adjustments to lap shade 10 to accommodate taller torso of a viewer, as shown in FIG. 7.

Moreover, lap shade 10 may be collapsed to a flat structure folded or flattened compactly into a small packet that can be easily carried in a storage compartment, pocket or bag or stowed in a pouch of a seat back or under a seat or compacted for shipping. It is recognized herein that one or more fold lines 28 of lap shade 10 may be positioned elsewhere on sides 22, 23, 24, and 25, and bottom 26 or around lap shade 10 create a bellows type collapsible/expandable lap shade 10. Moreover, lap shade 10 may include a break line such as separation line 28 configured to separate or break apart sides 22, 23, 24 and 25 and unfold lap shade 10. It is recognized herein that one or more separation lines 28 of lap shade 10 may be positioned elsewhere on sides 22, 23, 24, and 25, and bottom 26.

It is contemplated herein that lap shade 10 may be configured without, as shown, or with, bottom 26 and in use lap shade 10 may be positioned over a viewing device wherein the viewer looks down through lap shade 10 to view a clear glare free device.

Referring now to FIG. 7.1 there is illustrated a side view of an example embodiment of lap shade 10 shown with height extensions. Preferably, lap shade 10 includes an extension, such as collar 72 to enable height adjustments to lap shade 10 to accommodate taller torso viewers. Collar 72 preferably enables a viewer to set the height of lap shade 10 by choosing the degree of extension of collar 72 by sliding collar 72 up and down. Collar 72 is preferably releasably affixed to sides 22, 23, 24 and 25 by snap, button, snap-fit, friction fit, tongue and groove, hook and loop or the like, such as attachment device 74. Preferably collar 72 may be configured to fit around or slide on sides 22, 23, 24 and 25 of lap shade 10. Moreover, collar 72 preferably includes one or more cutouts, or holes, such as first aperture 32 and second aperture 42 configured to enable viewing access and releasably affixed thereto sides 22, 23, 24 and 25. Preferably, first aperture 32 includes one or more edges, such as edge 33, 35, 37, and 39 of FIG. configured as ‘goggle like’ or rounded to fit or accommodate a viewer's face and create a seal to block ambient light but other shapes for first aperture 32 are contemplated herein.

It is contemplated herein that collar 72 may be made available in a variety of sizes, sections and shapes to accommodate the torso and head size of larger viewers. Moreover, collar 72 may be collapsed to a flat structure folded or flattened compactly into a small packet that can be easily carried in a storage compartment, pocket or bag or stowed in a pouch of a seat back or under a seat or compacted for shipping. It is contemplated herein that collar 72 may be telescopic.

Referring now to FIG. 7.2 there is illustrated a side view of an example embodiment of lap shade 10 shown in use. Preferably lap shade 10 is positioned on a viewer's lap, a device may be inserted in second aperture 42, light L may be positioned within the interior of lap shade 10, a viewer may insert hand(s) therein second aperture 42 to operate such device, and a viewer may position their face in first aperture 32 to view such device without glare or ambient light to enable a clear view of the viewing device.

It is contemplated herein that a viewer may utilize lap shade 10 to read a book with a small reader light L in order to keep a bedroom dark and enable a clear view of the viewing device.

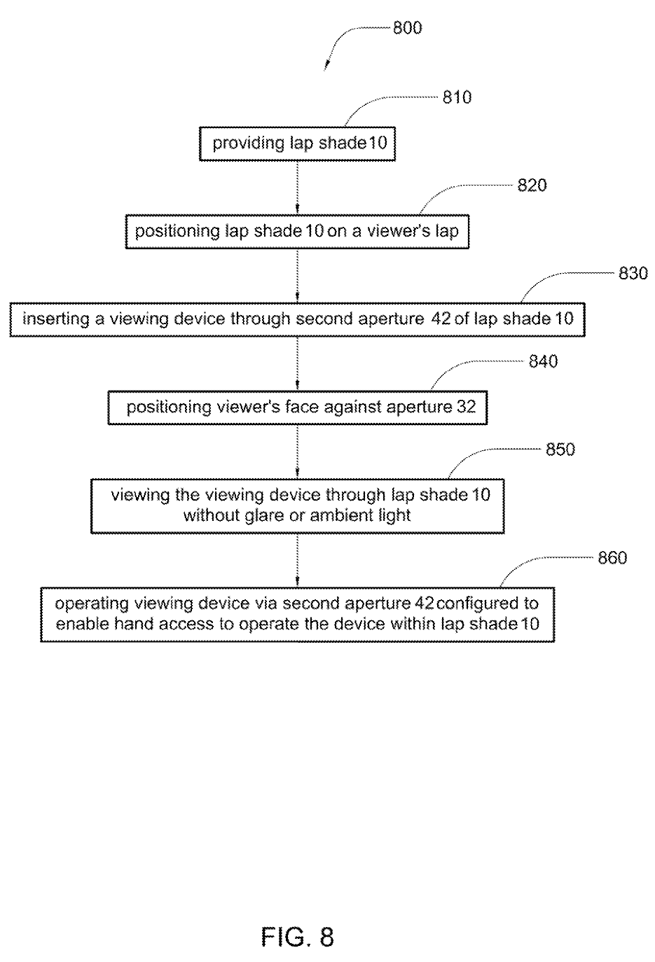

Referring now to FIG. 8, there is illustrated a flow diagram 800 a method of shielding glare. In block or step 810, providing lap shade 10 configured as a formed, cut or shaped set of polygons configured as a flexible planar shell, conduit or structure having one or more sides such as side 22, 23, 24, and 25, and/or bottom 26 arranged preferably as trapezoid or box-like sides forming a topped square based leaning pyramid for shielding or shading glare, as described above in FIGS. 1-7. In block or step 820, positioning lap shade 10 on a viewer's lap. In block or step 830, inserting a viewing device through second aperture 42 of lap shade 10. In block or step 840, positioning viewer's face against first aperture 32 configured as ‘goggle like’ or rounded to fit or accommodate a viewer's face and create a seal to block ambient light. In block or step 850, viewing the viewing device through lap shade 10 without glare or ambient light to enable a clear view of the viewing device. In block or step 860, operating the viewing device via second aperture 42 configured to enable hand access to operate the device within lap shade 10.

The foregoing description and drawings comprise illustrative embodiments of the present invention. Having thus described exemplary embodiments, it should be noted by those ordinarily skilled in the art that the disclosures within are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains, having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

Therefore, at least the following is claimed:

1. A lap shade to block light that causes glare on a display comprising:
a structure having one or more sidewalls configured to form a conduit, said structure further includes a first aperture positioned on a first end of said structure configured to conform to the users face; and
at least one second aperture positioned on a second and opposite end of said structure configured to encompass the display.

2. The lap shade of claim 1, wherein said one or more sidewalls further comprises a fold line configured to expand and contract said one or more sidewalls.

3. The lap shade of claim 1, wherein said first aperture further comprises at least one edge configured to create a seal to block ambient light.

4. The lap shade of claim 1, wherein said at least one edge further comprises a felt to create an additional seal to block ambient light.

5. The lap shade of claim 3, wherein said at least one edge is configured to be goggle shaped.

6. The lap shade of claim 1, further comprising a bottom positioned on a second and opposite end of said structure configured to form a base to said structure.

7. The lap shade of claim 6, wherein said at least one second aperture is configured to enable insertion of the display therein said structure.

8. The lap shade of claim 6, wherein said at least one second aperture is configured for hand insertion therein, to operate the device.

9. The lap shade of claim 8, wherein said at least one second aperture further comprises a fringe to create an additional seal to block ambient light.

10. The lap shade of claim 1, wherein said one or more sidewalls further comprises a third aperture configured to enable access therein of the device's power cord.

11. The lap shade of claim 2, wherein said fold line is configured to contract said one or more sidewalls for storage of said structure.

12. The lap shade of claim 2, wherein said fold line is configured to expand said one or more sidewalls to enable height adjustments to said structure to accommodate taller torso viewers.

13. The lap shade of claim 1, wherein said one or more sidewalls further comprises a separation line configured to separate said one or more sidewalls.

14. The lap shade of claim 13, wherein said separation line is further configured to break apart said one or more sidewalls for storage of said structure.

15. The lap shade of claim 1, further comprising a collar configured to enable height adjustments to said structure to accommodate taller torso viewers.

16. A lap shade to block light that causes glare on a display comprising:
a structure having one or more sidewalls configured to form a conduit, said structure further includes a first aperture positioned on a first end of said structure configured to conform to the users face;
a bottom positioned on a second and opposite end of said structure configured to form a base to said structure; and
at least one second aperture positioned on a second and opposite end of said structure configured to enable insertion of the display therein said structure.

17. The lap shade of claim 16, wherein said one or more sidewalls further comprises a fold line configured to expand and contract said one or more sidewalls.

18. The lap shade of claim 16, wherein said first aperture further comprises at least one edge configured to create a seal to block ambient light.

19. The lap shade of claim 16, wherein said at least one edge further comprises a felt to create an additional seal to block ambient light.

20. The lap shade of claim 19, wherein said at least one edge is configured to be goggle shaped.

21. The lap shade of claim 16, wherein said at least one second aperture is further configured for hand insertion therein, to operate the device.

22. The lap shade of claim 21, wherein said at least one second aperture further comprises a fringe to create an additional seal to block ambient light.

23. The lap shade of claim 16, wherein said bottom further comprises a third aperture configured to enable access therein of the device's power cord.

24. The lap shade of claim 17, wherein said fold line is configured to open said one or more sidewalls for use as a glare free viewing conduit.

25. The lap shade of claim 17, wherein said fold line is configured contract said one or more sidewalls for storage of said structure.

26. The lap shade of claim 17, wherein said fold line is configured to expand said one or more sidewalls to enable height adjustments to said structure to accommodate taller torso viewers.

27. The lap shade of claim 16, wherein said one or more sidewalls further comprises a separation line configured to separate said one or more sidewalls.

28. The lap shade of claim 27, wherein said separation line is further configured to break apart said one or more sidewalls for storage of said structure.

29. The lap shade of claim 16, further comprising a collar configured to enable height adjustments to said structure to accommodate taller torso viewers.

30. A method of shielding glare comprising the steps of:
providing a structure having one or more sidewalls configured to form a conduit, said structure further includes a first aperture positioned on a first end of said structure configured to conform to the users face, a bottom positioned on a second and opposite end of said structure configured to form a base to said structure, and at least one second aperture positioned on a second and opposite end of said structure configured to enable insertion of the display therein said structure;
positioning said structure on a viewer's lap;
inserting the device through at least one second aperture;
positioning the viewer's face against said first aperture; and
viewing the device through said structure without glare.

31. The method of claim 30, further comprising the step of operating the viewing device via said second aperture configured to enable hand access to operate the device within said structure.
